(19) United States
(12) Patent Application Publication
(10) Pub. No.: US 2009/0001836 A1
(43) Pub. Date: Jan. 1, 2009

(54) Spindle Motor

(76) Inventor: Chung Hyun Song, Gwangsan-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/147,569

(22) Filed: Jun. 27, 2008

(30) Foreign Application Priority Data
Jun. 28, 2007 (KR) 10-2007-0064035

(51) Int. Cl. H02K 21/22

(52) U.S. Cl. 310/156.08

(57) ABSTRACT

A spindle motor is provided. The spindle motor comprises a bearing housing, a bearing, a rotating shaft, a stator around, a rotor, and a first magnet. The bearing is fixed inside the bearing housing. The rotating shaft is rotatably inserted into the bearing. The stator surrounds the bearing housing. The rotor is fixed to the rotating shaft to rotate by interaction thereof with the stator. The first magnet surrounds the rotating shaft to attract the rotating shaft in one side direction.

### CROSS-REFERENCE TO RELATED APPLICATION

The present application claims priority under 35 U.S.C. 119(e) of Korean Patent Application No. 10-2007-0064035, filed Jun. 28, 2007, which is hereby incorporated by reference in its entirety.

### BACKGROUND

The present disclosure relates to a spindle motor.

A spindle motor is installed in an optical disk drive (ODD) in order to rotate a disk such that an optical pickup, which linearly reciprocates in the ODD, can read out data recorded on the disk.

FIG. 1 is a plan view of a related art spindle motor in which a rotating shaft supported in a bearing rotates.

Referring to FIG. 1, a bearing 10 press-fitted into a bearing housing (not shown) is prepared, and a rotating shaft 20 is rotatably inserted into and supported by the bearing 10.

The rotating shaft 20 rotates by an interaction between a stator (not shown) and a rotor (not shown). The rotating shaft 20 rotates while the rotating shaft 20 revolves along an inner peripheral surface of the bearing 10 due to a gap between an outer peripheral surface of the rotating shaft 20 and the inner peripheral surface of the bearing 10.

Thus, in the related art spindle motor, the rotating shaft 20 has a large rotating deviation in a radius direction because the rotating shaft 20 revolves along the inner peripheral surface of the bearing 10. The rotating deviation of the rotating shaft 20 in the radius direction causes a surface vibration in an axial direction of a disk mounted on a spindle motor. In particular, the surface vibration in the axial direction of the disk much increases when the rotating shaft rotates at a low speed.

### BRIEF SUMMARY

Embodiments provide a spindle motor that can interrupt a revolution of a rotating shaft to reduce a surface vibration in an axial direction of a disk.

Embodiments also provide a spindle motor that can interrupt floating of a rotor to reduce a surface vibration in an axial direction of a disk.

In one embodiment, a spindle motor comprises: a bearing housing; a bearing fixed inside the bearing housing; a rotating shaft rotatably inserted into the bearing; a stator around the bearing housing; a rotor fixed to the rotating shaft to rotate by interaction with the stator; and a first magnet around the rotating shaft to attract the rotating shaft in one direction.

In another embodiment, a spindle motor comprises: a bearing housing; a bearing fixed inside the bearing housing; a rotating shaft rotatably inserted into the bearing; a stator around the bearing housing; a rotor fixed to the rotating shaft to rotate by interaction with the stator; a first magnet around the rotating shaft to attract the rotating shaft in one direction; and one or more second magnets around the rotating shaft to attract the rotating shaft in a downward direction.

The details of one or more embodiments are set forth in the accompanying drawings and the description below. Other features will be apparent from the description and drawings, and from the claims.

### BRIEF DESCRIPTION OF THE DRAWINGS

FIG. 1 is a plan view of a related art spindle motor in which a rotating shaft supported in a bearing rotates.

FIG. 2 is a cross-sectional view of a spindle motor according to an embodiment.

FIG. 3 is a plan view of a spindle motor that removes a rotor illustrated in FIG. 2.

FIG. 4 is a plan view of a spindle motor in which a rotating shaft supported in a bearing rotates according to an embodiment.

FIG. 5 is a cross-sectional view of a spindle motor according to an embodiment.

FIG. 6 is a plan view of a spindle motor that removes a rotor illustrated in FIG. 5.

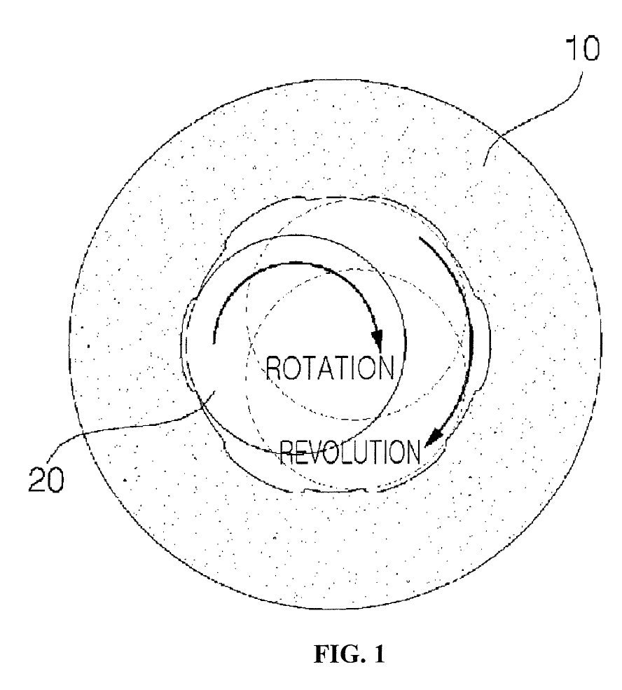

### DETAILED DESCRIPTION

Hereinafter, a spindle motor according to embodiments will be described in detail with reference to the accompanying drawings.

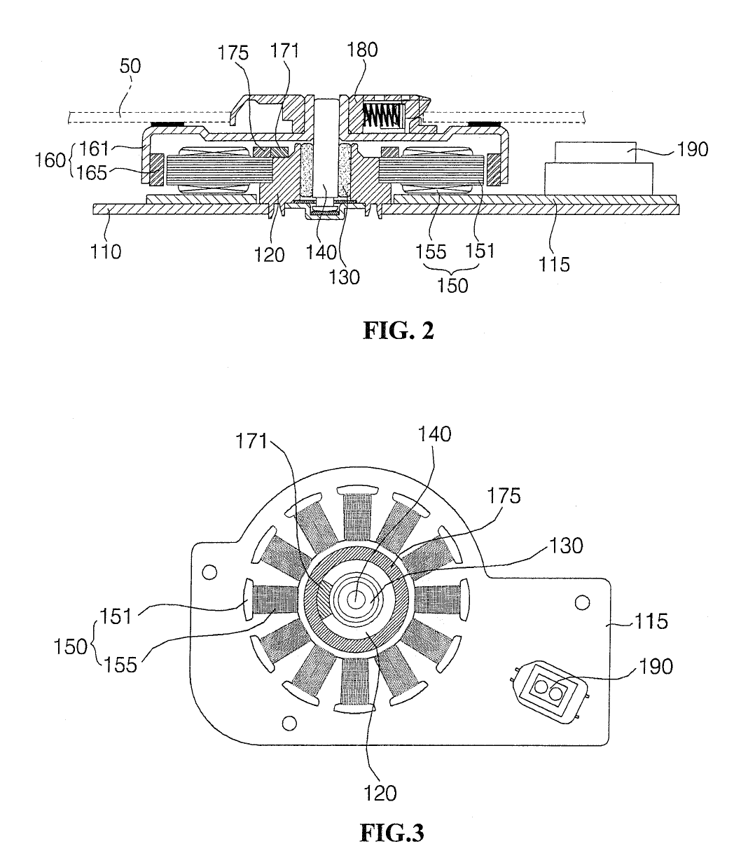

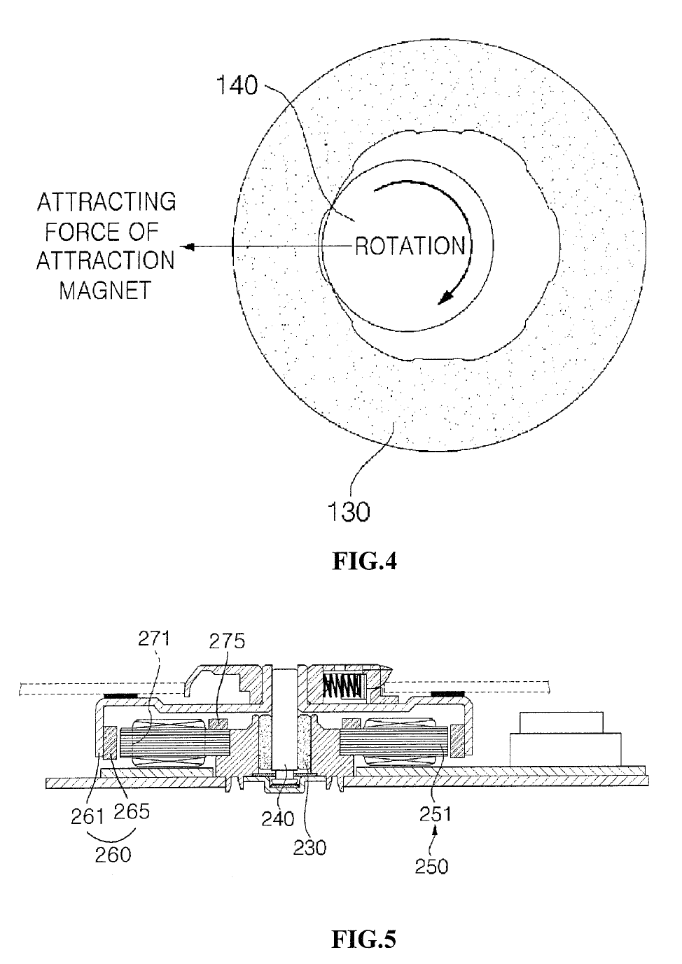

FIG. 2 is a cross-sectional view of a spindle motor according to an embodiment. FIG. 3 is a plan view of a spindle motor that removes a rotor illustrated in FIG. 2. FIG. 4 is a plan view of a spindle motor in which a rotating shaft supported in a bearing rotates according to an embodiment.

Referring to FIGS. 2 to 4, a bearing housing 120 is vertically disposed on a base 110. A bearing 130 is press-fitted into the bearing housing 120, and a lower portion of a rotating shaft 140 is rotatably supported to the bearing 130. The rotating shaft is formed of a magnetic material.

A stator 150 is fixed to the bearing housing 120, and a rotor 160 is fixed to the rotating shaft 140. The stator 150 includes a core 151 fixed to an outer peripheral surface of the bearing housing 110 and a coil 155 wound around the core 151. The rotor 160 includes a rotor yoke 161 and a magnet 165. The rotor yoke 161 is fixed to an outer peripheral surface of the rotating shaft 140 exposed toward an upper side of the bearing housing 120. The magnet 165 is coupled to an inner peripheral surface of the rotor yoke 161.

When a current is applied to the coil 155, the rotor 160 rotates due to an electromagnetic force generated between the coil 155 and the magnet 165, so that the rotating shaft 140 also rotates. A disk 50 is mounted on the rotor yoke 161.

A gap exist between the outer peripheral surface of the rotating shaft 140 and an inner peripheral surface of the bearing 130 in order to smoothly rotate the rotating shaft 140 inserted into and supported by the bearing 130. Due to the gap between the outer peripheral surface of the rotating shaft 140 and the inner peripheral surface of the bearing 130, the rotating shaft 140 rotates, and at the same time, revolves along the inner peripheral surface of the bearing 130 while the rotating shaft 140 is in contact with the inner peripheral surface of the bearing 130.

The spindle motor according to this embodiment provides a device that can interrupt the revolution of the rotating shaft 140 to reduce a rotating deviation in a radius direction.

The device may be implemented using a first attraction magnet 171 fixed to an upper surface of the bearing housing 120 to attract the rotating shaft 140 to one side of the bearing 130. Referring to FIG. 4, by the first attraction magnet 171, the rotating shaft 140 does not revolve, but only rotates while the rotating shaft 140 is in contact with an inner peripheral surface of a side of the bearing 130.

Thus, a surface vibration of the disk 50 mounted on the rotor yoke 161 rotatably fixed to the rotating shaft 140 is reduced because the rotating deviation in a radius direction of the rotating shaft 140 is not generated.

Although not shown, the first attraction magnet 171 may be installed around the bearing housing 120. Also, the first attraction magnet 171 may be installed at side surface of the bearing housing 120. Also, the first attraction magnet 171 may be separated from the bearing housing 120.

Not explained reference numeral 155 denotes a substrate, and not explained reference numeral 175 denotes a second attraction magnet having a ring shape. The second attraction magnet is installed at the core 151 of the stator 150 to attract the rotor yoke 161, thereby preventing the rotor 160 from being floated. The second attraction magnet 175 surrounds the first attraction magnet 171. When the first attraction magnet 171 is disposed inside an upper surface of the bearing housing 120, the second attraction magnet 175 may be disposed outside the upper surface of the bearing housing 120.

In the embodiment, the second attraction magnet 175 does not attract the rotating shaft 140, but only interrupts the floating of rotor 160. For this, the second attraction magnet 175 has the ring shape and is disposed with respect to the rotating shaft 140.

Although not shown, a plurality of second attraction magnets 175 may be disposed at positions of point symmetry with respect to the rotating shaft 140. When the plurality of second attraction magnets 175 is disposed at the positions of the point symmetry with respect to the rotating shaft 140, a force acting on the rotating shaft 140 is offset and only a force acting on the rotor 160 remains.

Not explained reference numeral 180 denotes a clamp elastically supporting the disk 50 such that a center of the disk 50 mounted on the rotor yoke 161 accords with a center of the rotating shaft 140, and not explained reference numeral 190 denotes an encoder detecting whether the disk 50 rotates at a low speed of 40 rpm when a design pattern is printed on a surface of the disk 50.

In the spindle motor according to the embodiment, the first attraction magnet 171 and the second attraction magnet 175 can reduce the surface vibration in an axial direction of the disk 50 when the disk 50 rotates at the low speed.

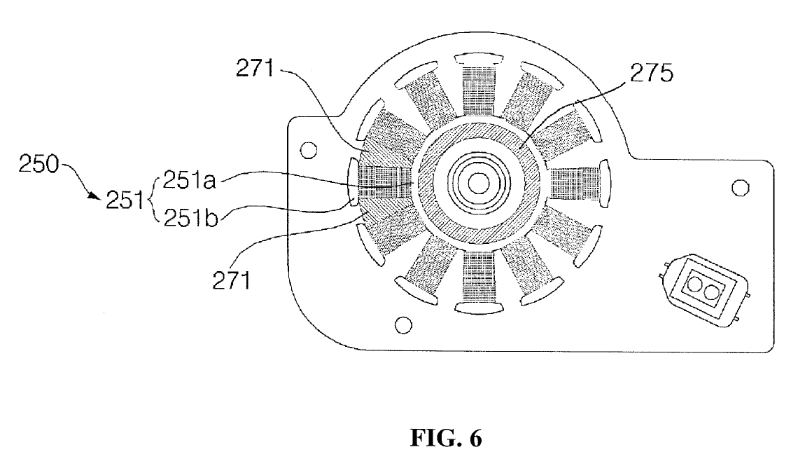

FIG. 5 is a cross-sectional view of a spindle motor according to an embodiment, and FIG. 6 is a plan view of a spindle motor that removes a rotor illustrate in FIG. 5. Only the points that are different from FIGS. 2 and 3 will be described.

Referring to FIGS. 5 and 6, the device may be implemented using a first attraction magnet 271 fixed to a stator 250 to attract a rotating shaft 240 to one side of a bearing 230. A core 251 of the stator 250 includes a body 251a having a ring shape and a plurality of arms 251b equidistantly extending form an outer peripheral surface of the body 251a. The first attraction magnet 271 is fixedly inserted into a space between the arm 251b and an arm 251b adjacent to the arm 251b.

Although not shown, the first attraction magnet 271 may be installed on the arm 251b.

Also, the first attraction magnet 271 may be installed on the body 251a.

A second attraction magnet 275 having a ring shape is installed at the core 251 of the stator 250 to attract a rotor yoke 261, thereby preventing the rotor 160 from being floated.

In the embodiment illustrated in FIG. 2, the first attraction magnet 171 is greater adjacent to the rotating shaft 140 than the second attraction magnet 175. In the embodiment illustrated in FIG. 5, the second attraction magnet 275 is greater adjacent to the rotating shaft 140 than the first attraction magnet 271.

As described above, in the spindle motor according to the present disclosure, the rotating shaft is attracted into one side of the bearing by the attraction magnet fixed to the bearing housing or the stator. Thus, since the rotating shaft only rotates while the rotating shaft is in contact with the inner peripheral surface of one side of the bearing, the rotating deviation in the radius direction of the rotating shaft is not generated. Therefore, the surface vibration of the disk mounted on the rotor yoke rotatably fixed to the rotating shaft can be reduced.

The spindle motor according to the present disclosure provides the spindle motor that can interrupt the levitation of the rotor to reduce the surface vibration in the axial direction of the disk.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A spindle motor comprising:
a bearing housing;
a bearing fixed inside the bearing housing;
a rotating shaft rotatably inserted into the bearing;
a stator around the bearing housing;
a rotor fixed to the rotating shaft to rotate by interaction with the stator; and
a first magnet around the rotating shaft to attract the rotating shaft in one direction.

2. The spindle motor according to claim 1, wherein the first magnet is fixed to the bearing housing.

3. The spindle motor according to claim 2, wherein the first magnet is fixed to an upper surface of the bearing housing.

4. The spindle motor according to claim 1, wherein the first magnet is installed around the bearing housing.

5. The spindle motor according to claim 1, wherein the first magnet is separated from the bearing housing.

6. The spindle motor according to claim 1, wherein the first magnet is fixed to the stator.

7. The spindle motor according to claim 6, wherein the stator comprises a core fixed to an outer peripheral surface of the bearing housing and a coil wound around the core, and the core comprises a body having a ring shape and a plurality of arms extending form an outer peripheral surface of the body.

8. The spindle motor according to claim 7, wherein the first magnet is installed on the body.

9. The spindle motor according to claim 7, wherein the first magnet is installed on the arm.

10. The spindle motor according to claim 7, wherein the first magnet is inserted into a space between one of the arms and another arm adjacent to the one.

11. The spindle motor according to claim 1, further comprising one or more second magnets attracting the rotor in a downward direction.

12. The spindle motor according to claim 11, wherein the second magnet is fixed to the bearing housing.

13. The spindle motor according to claim 12, wherein the one or more second magnets are disposed at positions of point symmetry with respect to the rotating shaft.

14. The spindle motor according to claim 11, wherein the second magnet has a ring shape.

15. A spindle motor comprising:
a bearing housing;
a bearing fixed inside the bearing housing;
a rotating shaft rotatably inserted into the bearing;
a stator around the bearing housing;
a rotor fixed to the rotating shaft to rotate by interaction with the stator;
a first magnet around the rotating shaft to attract the rotating shaft in one direction; and
one or more second magnets around the rotating shaft to attract the rotor in a downward direction.

16. The spindle motor according to claim 15, wherein the second magnet is fixed to the stator.

17. The spindle motor according to claim 15, wherein the first magnet is greater adjacent to the rotating shaft than the second magnet.

18. The spindle motor according to claim 15, wherein the second magnet is greater adjacent to the rotating shaft than the first magnet.

19. The spindle motor according to claim 15, wherein the second magnet is adjacent to a bottom surface of the rotor than the first magnet.

20. The spindle motor according to claim 15, wherein the one or more second magnets are disposed at positions of point symmetry with respect to the rotating shaft.
